(19) United States
(12) Patent Application Publication
(10) Pub. No.: US 2005/0003327 A1
(43) Pub. Date: Jan. 6, 2005

(54) Drilling system and method for dental implants

(76) Inventors: Nicolas Elian, Tenafly, NJ (US); Jeff Scolnick, Great Neck, NY (US); Sang Choon-Cho, New York, NY (US); Moshe Meller, New York, NY (US)

Correspondence Address: FRISHAUF, HOLTZ, GOODMAN & CHICK, PC, 767 THIRD AVENUE, 25TH FLOOR, NEW YORK, NY, 10017-2023, US

(21) Appl. No.: 10/843,960

(22) Filed: May 11, 2004

Related U.S. Application Data
(60) Provisional application No. 60/469,726, filed on May 12, 2003.
(60) Provisional application No. 60/479,108, filed on Jun. 16, 2003.

(51) Int. Cl. A61C 8/00; A61C 3/02

(52) U.S. Cl. 433/165; 433/173

(57) ABSTRACT

Method for drilling a hole for placement of an implant therein in which an initial hole is formed in the jaw bone having a diameter smaller than a desired diameter for placement of the implant and a depth smaller than a desired depth for placement of the implant. A flat ledge is formed in the bone around the initial hole by the same drill bit which forms the initial hole. The initial hole is then enlarged to the desired diameter and the desired depth using another drill bit which is designed to contact the ledge when the initial hole has been enlarged to exactly the desired depth. Penetration of the drill bit into the jaw bone once the hole has been enlarged to the desired depth is therefore prevented.

### CROSS-REFERENCE TO RELATED APPLICATIONS

This application claims priority under 35 U.S.C. §119(e) of U.S. provisional patent application Ser. No. 60/469,726 filed May 12, 2003 and U.S. provisional patent application Ser. No. 60/479,108 filed Jun. 16, 2003, both of which are incorporated by reference herein.

### FIELD OF THE INVENTION

The present invention relates generally to a drilling system and method for drilling holes for dental implants and more particularly to drill bits which can be used to drill holes for dental implants and a method for using the same.

### BACKGROUND OF THE INVENTION

When surgically implanting a dental implant in a patient, the standard drilling protocol involves a sequence of drills with multiple drilling lines which guide the dentist while drilling holes into which the implants are placed.

There are several important factors which influence the success of the implant surgery, i.e., the proper placement of the implant. One factor is the positioning of the initial drilled hole in the jaw bone which is critical since the subsequent drillings depend on this initial drilled hole. Another factor is the accuracy of the depth of the completed, drilled hole into which the implant is placed.

One problem with the standard drilling protocol is that it is difficult to clearly view the drilling lines and this often adversely affects the formation of the holes in the patient's jaw bone.

Another problem is that since conventional drills usually have a pointed drilling end, the dentist is liable to drill into the jaw bone a distance which is greater than the height of the dental implant thus creating potential problems in the placement of the implant. The extra length with some implant systems could be as large as about 1.25 mm.

Accordingly, it would be beneficial to have a drilling system and method for drilling holes for dental implants which limits the penetration of a drill into the jaw bone. This penetration limit could be the depth required for placement of the dental implant so that the dental implant is optimally placed in the jaw bone.

### OBJECT AND SUMMARY OF THE INVENTION

It is an object of the present invention to provide a new drilling system and method for drilling holes for dental implants which limits the penetration of the drill into the jaw bone and thereby prevents overdrilling, i.e., drilling further than the required depth for placement of the dental implant.

It is another object of the present invention to provide a new drilling system and method for drilling holes for dental implants which utilizes drills with flat ends which aid in preventing overdrilling.

It is yet another object of the present invention to provide a new system and method for drilling the initial hole for a dental implant in which the position of the initial hole is determined in an optimal, accurate and simple manner.

In order to achieve these objects and others, a method for drilling a hole for placement of an implant therein comprises forming an initial hole in the jaw bone having a diameter smaller than a desired diameter for placement of the implant and a depth smaller than a desired depth for placement of the implant, forming a flat ledge around the initial hole, and enlarging the initial hole to the desired diameter and the desired depth using a drill bit formed to contact the ledge when the initial hole has been enlarged to exactly the desired depth. In this manner, penetration of the drill bit into the jaw bone once the hole has been enlarged to the desired depth, i.e., overdrilling, is effectively prevented.

Formation of the initial hole and the ledge is preferably accomplished using a single drill bit. Such a drill bit preferably include a tip drill portion which engages and penetrates the jaw bone first, a cylindrical drill portion adjacent the tip drill portion and a cutting disc adjacent the cylindrical drill portion. The cutting disc has a larger diameter than a diameter of the cylindrical drill portion and a lower cutting surface facing the tip drill portion which mills or cuts the bone in a planar manner to thereby form the ledge.

The drill bit used to enlarge the initial hole preferably includes a cylindrical drill portion having the desired diameter of the hole and a stopper ring spaced from a lower edge of the cylindrical drill portion a distance equal to the desired depth. The cylindrical drill portion has a substantially flat lower edge at which a cutting tooth is formed to provide the drilled hole with a flat bottom surface. The stopper ring has a diameter substantially equal to a diameter of the ledge, i.e., substantially equal to the diameter of the cutting disc, such that the stopper ring contacts the ledge when the hole has the desired depth.

The stopper ring can be formed separate and apart from the cylindrical drill portion and removably attached to the cylindrical drill portion in a position against a stopper formed in connection with the cylindrical drill portion and/or shank. In this case, a plurality of stopper rings with different lengths can be provided so that an effective cutting depth of the drill bit is adjustable depending on which stopper ring is attached to the cylindrical drill portion. Alternatively, the stopper ring can be permanently fixed to the cylindrical drill portion and/or shank.

Other and further objects, advantages and features of the present invention will be understood by reference to the following specification in conjunction with the annexed drawings, wherein like parts have been given like numbers.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a front view of a drill bit in accordance with the invention for drilling the initial hole in a dental implant surgery.

FIG. 2 is a view of the jaw bone after drilling by the drill bit shown in FIG. 1.

FIG. 3 is a front view of another embodiment of a drill bit in accordance with the invention for drilling the initial hole in a dental implant surgery.

FIG. 4 is a front view of a drill bit in accordance with the invention for enlarging the initial hole.

FIG. 5 is a view of the jaw bone during drilling with the drill bit shown in FIG. 4.

### DETAILED DESCRIPTION OF THE INVENTION

Referring to the accompanying drawings wherein like reference numerals refer to the same or similar elements, a method for drilling a hole in the jaw bone for placement of a dental implant involves drilling an initial hole using one drill bit and then enlarging the hole using one or more additional drill bits. In accordance with the invention, the initial hole is drilled using the drill bit shown in FIG. 1 and designated generally as 10. The drill bit 10 includes a cylindrical shank 12, a stopper portion 14, a milling or cutting disc 16, a cylindrical drill portion 18 and a tip drill portion 20. Shank 12 is dimensioned to be connectable to a dental hand piece in a manner known to those skilled in the art, i.e., it has a diameter of 2.35 mm.

The stopper portion 14 and the cutting disc 16 have approximately the same diameter which may be in a range from about 3.25 mm to about 5.0 mm, e.g., 3.25 mm, 4.1 mm and 5.0 mm.

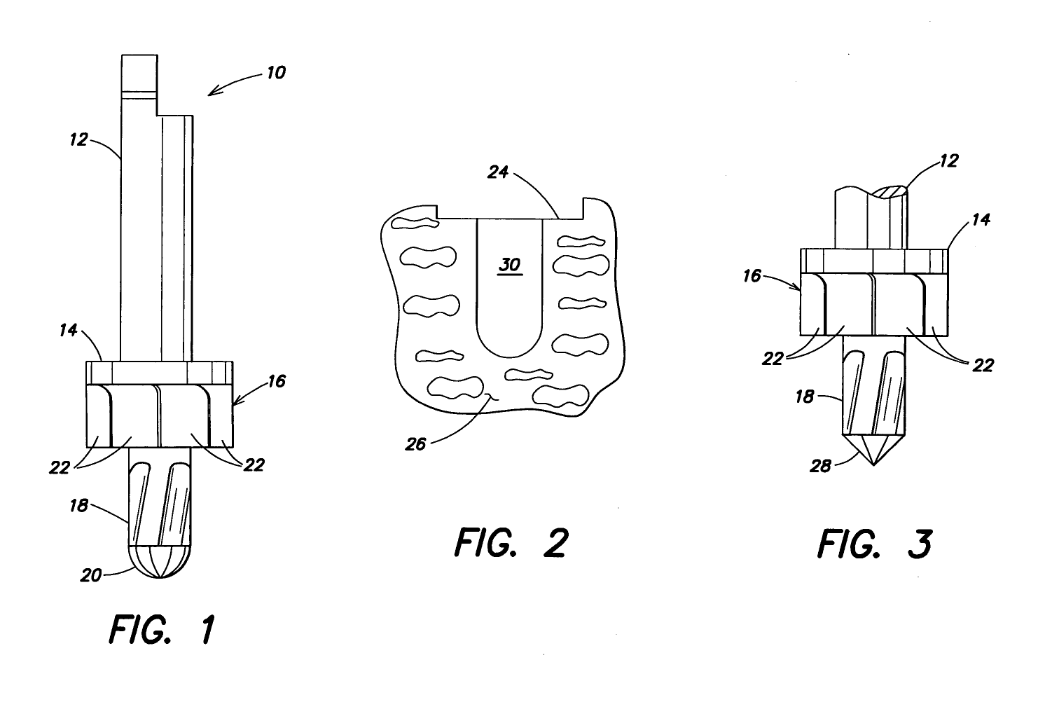

Cutting disc 16 is provided with cutting blades 22 which cut or mill the crestal bone 26 to form a substantially flat ledge 24 in the bone 26 which is used in the subsequent drilling (see FIG. 2). The cutting disc 16 can be formed separate from the shank 12, stopper portion 14, cylindrical drill portion 18 and tip drill portion 20 and attached thereto prior to use, e.g., permanently or removably attached thereto. In this case, the flutes of the cylindrical drill portion 18 could extend only part of the distance to the stopper portion 14 and the cutting disc 16 would be placed on the non-fluted section of the cylindrical drill portion 18 adjacent the stopper portion 14.

The cylindrical drill portion 18 has a smaller diameter than the diameter of the stopper portion 14 and cutting disc 16, for example, about 2.0 mm. Other diameters for the cylindrical drill portion 18 are also envisioned for the invention.

Tip drill portion 20 is a ball-shaped burr which makes the initial penetration into the bone when drilling the initial hole 30 for the dental implants. Instead of a ball-shaped burr, a conical burr 28 can be provided (see FIG. 3). Other forms of a burr for penetrating initially into the bone can also be used in accordance with the invention.

To drill the initial hole 30, the dentist mounts the drill bit 10 onto the hand piece, preferably a hand piece capable of a rotational speed of about 1500 rpm, and proceeds to press the drill bit 10 against the jaw bone 26 at the site of the center of the implant. As the drill bit 10 rotates, the initial hole 30 is formed with a shape corresponding to the shape of the drill tip portion 20 and the cylindrical portion 18 (see FIG. 2). The drilling continues until the cutting disc 16 engages an upper surface of the bone 26 and thereafter until a discernible ledge 24 is formed. Once the ledge 24 is formed, drilling with the drill bit 10 can be stopped and the drill bit 10 removed from engagement with the bone 26.

The initial hole 30 has thus been prepared for subsequent drilling and enlargement, and thereafter for placement of the implant in the enlarged hole.

The use of the drill bit 10 to drill the initial hole 30 provides advantages in that the dentist has a significantly better orientation and opportunity to correct the drilling position of the initial hole 30, if desired or required. That is, if the dentist realizes that the initial hole 30 will be unsuitable or simply non-optimal for the implant, which might be gleaned once only the drill tip portion 20 has drilled into the bone 26, the dentist can drill another initial hole 30 at a more desirable site. The originally drilled initial hole 30 does not interfere with the subsequent hole for the dental implant because the size of the initial hole 30 is smaller than the size of a hole needed for a conventional dental implant, i.e., the length of the drill bit 10 from the lower edge of the stopper portion 14 might only be about 7.0 mm whereas the depth of a hole for a dental implant may be 13.0 mm.

Another advantage is that the drilling of the initial hole 30 using drill bit 10 preserves interproximal bone which supports the interproximal papilla to achieve esthetic implant restorations.

Once the initial hole 30 is drilled, the dentist then proceeds to enlarge the hole 30 to the diameter and depth required for the particular implant.

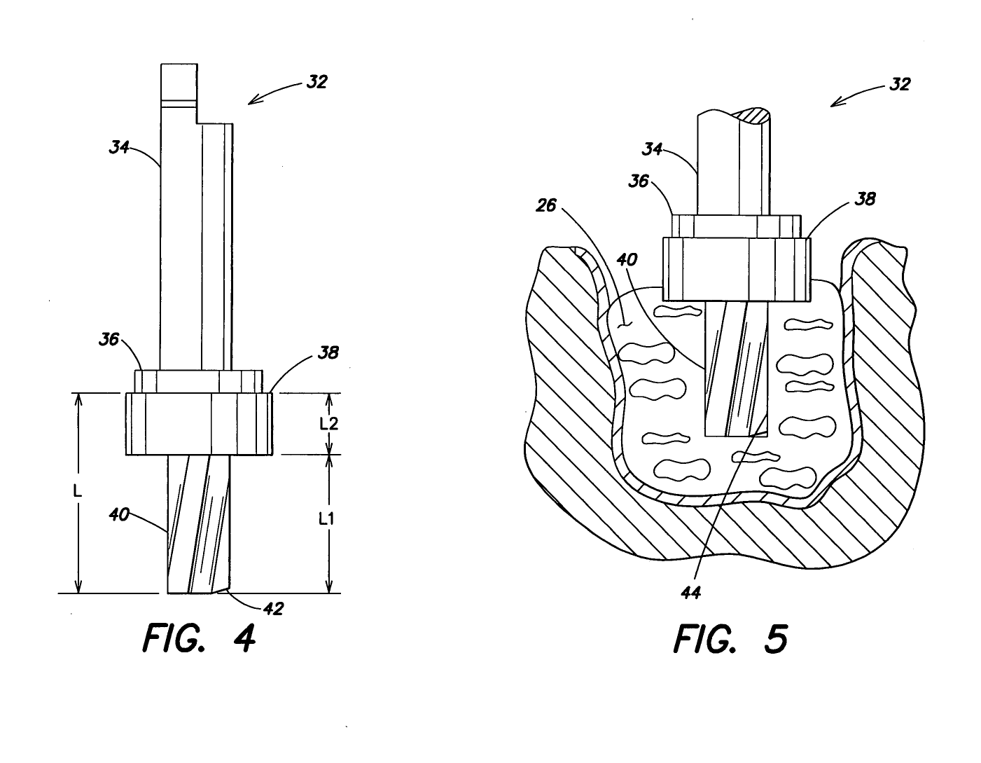

Enlargement of the initial hole 30 is performed using one or more additional drill bits 32, one of which is shown in FIG. 4. Drill bit 32 includes a cylindrical shank 34, a stopper 36 formed in connection with the shank 34, a stopper ring 38 arranged against the stopper 36 and a cylindrical drill portion 40 having a cutting tooth 42 at a lower edge. Shank 34 is dimensioned to be connectable to a dental hand piece in a manner known to those skilled in the art, i.e., it has a diameter of 2.35 mm.

The diameter of the cylindrical drill portion 40 corresponds to the desired diameter of the final, drilled hole 44. The diameter of the stopper ring 38 corresponds to the diameter of the stopper portion 14 of the drill bit 10, both of which should correspond to the diameter of the implant.

The diameter of the stopper 36 is generally larger than the diameter of the cylindrical drill portion 40. For example, a range of possible diameters of the cylindrical drill portion 40 is from about 2.0 mm to about 4.25 mm whereas a range of possible diameters of the stopper 36 is from about 3.25 mm to about 5.0 mm. In one embodiment, the diameter of the stopper 36 is 3.25 mm while the diameter of the cylindrical drill portion 40 is 2.0 mm or 2.75 mm. In other embodiments, the diameter of the stopper 36 is 4.1 mm while the diameter of the cylindrical drill portion 40 is 3.0 mm and the diameter of the stopper 36 is 5.0 mm while the diameter of the cylindrical drill portion 40 is 4.25 mm.

The cylindrical drill portion 40 may include two or more flutes, possibly spiral flutes, which extend over only a part of the cylindrical drill portion 40. The stopper ring 38 could be placed at least partially on the non-fluted portion of the cylindrical drill portion 40. The cutting tooth 42 is preferably formed at a substantially planar lower edge of the cylindrical drill portion 40 so that the drilled hole 44 is provided with a flat bottom surface.

The stopper ring 38 determines the cutting depth of the drill bit 32, which is the distance between the lower edge of the stopper ring 38 and the lower edge of the cylindrical drill portion 40 (L1). Thus, a plurality of different drill bits 32 can be formed, all having the same length (L) between the lower edge of the stopper 36 and the lower edge of the cylindrical drill portion 40, but with stopper rings 38 having different lengths (L2). Thus, the cutting depth (L1) of each drill bit 32 would be L-L2, with L2 being variable between the different drill bits 32.

In some embodiments, the stopper ring 38 can be integrally formed with the shank 34 and cylindrical drill portion 40, and optionally the stopper 36 which might even be omitted in such embodiments. In this case, a plurality of drill bits 32 would be required to drill holes with different depths. Alternatively, the stopper ring 38 could be formed separate and apart from the shank 34, stopper 36 and cylindrical drill portion 40 and slidable onto the cylindrical drill portion 40 until it engages with the stopper 36. In this case, different length stopper rings 38 could be formed and used with the same drill bit 32. The stopper rings 38 selected for use with the drill bit 32 would be the one with the length which provides the desired drill depth.

In yet another embodiment, the stopper ring 38 is not formed integral with the shank 34, stopper 36 and cylindrical drill portion 40, but is slid over the cylindrical drill portion 40 and pressed and fixed thereto. A significant advantage of this embodiment is that a single mold for the shank 34, stopper 36 and cylindrical drill portion 40 can be created and used and drill bits 32 with different cutting depths formed by pressing different sizes of stopper rings 38 onto the cylindrical drill portion 40 of each drill bit 32. The costs of drill production would therefore be significantly reduced.

When attached to or formed integral with the cylindrical drill portion 40, stopper ring 38 is preferably formed from stainless steel. When the stopper rig 38 is removable from the cylindrical drill portion 40, it can be formed from plastic, aluminum or any other material compatible for dental use.

The placement of the base of a dental implant using the drill bits 10, 32 in accordance with the invention thus proceeds as follows. First, the initial hole 30 is drilled in the manner described above. Thereafter, the depth of the hole 44 needed for the particular implant base is determined and an appropriate drill bit 32 is selected. The selected drill 32 would have a cutting depth (L1) equal to the desired hole depth. A drill bit 32 with a permanently attached or integral stopper ring 38 could be used or if a drill bit 32 with a removable stopper ring 38 can be used, in which case, the length of the stopper ring 32 is determined using the formula L2=L−L1, i.e., the total length of the cylindrical drill portion less the desired cutting depth equals the length of the stopper ring 38 required to provide the desired cutting depth, and a stopper ring 38 of this size is then placed onto the cylindrical drill portion 40 against the stopper 36.

Drilling with the selected drill bit 32 commences and proceeds until the stopper ring 38 contacts the ledge 24. Further penetration of the drill bit 32 into the bone or other anatomic structure is automatically prevented when the stopper ring 38 contacts the ledge 24 because the stopper ring 38 does not contain any cutting or milling implements and is thus unable to cut through the ledge 24 formed in the bone 26. Accordingly, the hole 44 thus has exactly the desired depth for placement of the implant. The enables stabilizing position and horizontal angulations of the drill bits 10, 32 and implants leading to a reduction in the time required for the implant surgery and the placement of the implant in a more precise position. In addition, unnecessary reduction of alveolar bone 26 is minimized so that a dentist can perform a dental implant restoration easier and at a high quality.

Once the hole 44 for the base of the implant is formed, the implant is then screwed into the hole 44. This is facilitated by the presence of the ledge 24 which preferably has a diameter corresponding to the implant diameter.

Accordingly, in the method for drilling a hole for an implant, at least two drill bits are used with the first drill bit having both a penetration portion which forms a small initial hole 30, i.e., the cylindrical drill portion 18 and the drill tip portion 20, and a milling portion which forms a flat ledge at an entrance to the initial hole, i.e., the cutting disc 16. The construction of the milling portion of this first drill bit with a diameter close to the diameter of the implant aids in the subsequent drilling to enlarge the initial hole 30 as well as the placement of the implant base into the enlarged hole 44.

Advantages of the drilling method and system described above include the implementation of a disposable system which keeps the sharpness of the drills and minimizes the possibility of cross-infection which might arises when drills are used repeatedly for different patients.

While the invention has been described above with respect to specific apparatus and specific implementations, it should be clear that various modifications and alterations can be made, and various features of one embodiment can be included in other embodiments, within the scope of the present invention.

1. A method for drilling a hole for placement of an implant therein, comprising the steps of:
forming an initial hole in the jaw bone having a diameter smaller than a desired diameter for placement of the implant and a depth smaller than a desired depth for placement of the implant;
forming a flat ledge in the bone around the initial hole;
enlarging the initial hole to the desired diameter and the desired depth using a drill bit; and
forming the drill bit to contact the ledge when the initial hole has been enlarged to exactly the desired depth to thereby prevent further penetration of the drill bit into the jaw bone once the hole has been enlarged to the desired depth.

2. The method of claim 1, wherein the initial hole and flat ledge are formed using a common drill bit.

3. The method of claim 2, wherein the step of forming the initial hole comprises the step of providing the common drill bit with a tip drill portion which engages and penetrates the jaw bone and a cylindrical drill portion adjacent the tip drill portion.

4. The method of claim 3, wherein the step of forming the ledge comprises the step of providing the common drill bit with a cutting disc adjacent the cylindrical drill portion and having a larger diameter than a diameter of the cylindrical drill portion, the cutting disc having a lower cutting surface facing the tip drill portion.

5. The method of claim 3, wherein the tip drill portion is a ball-shaped burr.

6. The method of claim 3, wherein the tip drill portion is a conical burr.

7. The method of claim 1, wherein the step of forming the drill bit comprises the step of providing the drill bit with a cylindrical drill portion having the desired diameter of the hole and a stopper ring spaced from a lower edge of the cylindrical drill portion a distance equal to the desired depth, the lower edge of the cylindrical drill portion being flat, the stopper ring having a diameter substantially equal to a diameter of the ledge such that the stopper ring contacts the ledge when the hole has the desired depth.

8. The method of claim 7, wherein the step of forming the drill bit comprises the steps of forming the stopper ring separate and apart from the cylindrical drill portion, forming a stopper on the cylindrical drill portion and removably attaching the stopper ring to the cylindrical drill portion in a position abut against the stopper.

9. The method of claim 8, further comprising the step of providing a plurality of stopper rings each having a different length such that an effective cutting depth of the drill bit is adjustable depending on which stopper ring is attached to the cylindrical drill portion.

10. The method of claim 7, wherein the stopper ring is permanently fixed to the cylindrical drill portion.

11. A drill bit, comprising:
a shank connectable to a dental hand piece;
a tip drill portion arranged at an end of the drill bit opposite said shank;
a cylindrical drill portion arranged adjacent said tip drill portion; and
a cutting disc having a lower cutting surface facing said tip drill portion, said cutting disc having a larger diameter than a diameter of said cylindrical drill portion.

12. The drill bit of claim 11, wherein said tip drill portion is a ball-shaped burr.

13. The drill bit of claim 11, wherein said tip drill portion is a conical burr.

14. A drill bit, comprising:
a shank connectable to a dental hand piece;
a cylindrical drill portion arranged at an end of the drill bit opposite said shank, said cylindrical drill portion having a cutting tooth at a lower, substantially flat edge; and
a stopper ring arranged on said cylindrical drill portion and having a diameter larger than a diameter of said cylindrical drill portion, an effective cutting depth of the drill bit being defined by the distance between a lower edge of said stopper ring and a lower edge of said cylindrical drill portion.

15. The drill bit of claim 14, further comprising a stopper arranged on said shank, said stopper ring being arranged between said stopper and said cutting tooth.

16. The drill bit of claim 15, wherein said stopper ring is removably attached to said cylindrical drill portion.

17. The drill bit of claim 15, wherein said stopper has a diameter larger than a diameter of said cylindrical drill portion.

18. The drill bit of claim 13, wherein said stopper ring is fixed to said cylindrical drill portion.
